(19) United States
(12) Patent Application Publication
(10) Pub. No.: US 2008/0160453 A1
(43) Pub. Date: Jul. 3, 2008

(54) Method for manufacturing a field emission display

(75) Inventors: Hung-Yuan Li, Banciao City (TW); Tsuey-May Yin, Taipei (TW); Tsai-Ling Ho, Taipei (TW)

Correspondence Address: BACON & THOMAS, PLLC, 625 SLATERS LANE, FOURTH FLOOR, ALEXANDRIA, VA, 22314, US

(73) Assignee: Tatung Company, Taipei (TW)

(21) Appl. No.: 11/812,401

(22) Filed: Jun. 19, 2007

(30) Foreign Application Priority Data
Dec. 29, 2006 (TW) 095149944

(51) Int. Cl. G03C 5/28; G03C 5/29

(52) U.S. Cl. 430/319

(57) ABSTRACT

The present invention provides a method for manufacturing a cathode panel of a field emission display, comprising: (a) providing a plate comprising a cathode layer and an emitter layer, wherein the cathode layer and the emitter layer are disposed on the upper surface of the plate; (b) forming a photosensitive insulating layer on the upper surface of the plate; (c) exposing the upper surface of the plate which comprises the photosensitive insulating layer; (d) developing the photosensitive insulating layer on the plate to form a patterned insulating layer; and (e) sintering the patterned insulating layer on the plate, wherein, the photosensitive insulating layer performs a cross-linking reaction after exposure.

### BACKGROUND OF THE INVENTION

1. Field of the Invention

The present invention relates to a method for manufacturing a field emission display and, more particularly, to a method for manufacturing a cathode panel of a field emission display.

2. Description of Related Art

Electronic displays are more and more important for daily life. In addition to computers or the internet, televisions, mobile phones, personal digital assistants, and digital cameras all need displays to express signals. In comparison with a conventional cathode ray tube based display, a new flat panel display exhibits advantages of light-weight, compact-size, and reduced health damage but the issues of view angle, brightness, power consumption and so on still need to be improved.

Among new flat panel displays, a field emission display (FED) not only has high-quality equal to that of a conventional cathode ray tube based display, but also has the advantages of short reaction time, excellent display performance, high brightness, light and thin structure, wide view angle, broad range of action temperature and so on.

A carbon nanotube based field emission takes carbon nanotube for tip discharge to replace a conventional element for tip discharge, which has short lifetime and is not readily manufactured. Thereby, it is believed that a field emission display [is believed that it] has the ability to compete with a liquid crystal display, and can even replace a liquid crystal display.

However, since the demand for high resolution continues to rise, a field emission display manufactured by a conventional screen printing process cannot meet the requirements. The major reason for that failure is that in broad-area screen printing process, the less precise position of a screen [would] causes the difficulty of alignment. In particular, the shift between layers [would] often occurs in high resolution and this causes the failings of printing. Therefore, it is desirable to provide a manufacturing method to overcome the aforementioned problems.

### SUMMARY OF THE INVENTION

The major object of the present invention is to provide a method for manufacturing a cathode panel of a field emission display so as to improve the alignment issues in time-consuming screen printing, obtain precise patterns, simplify the process routine, reduce time and cost for the manufacture, and enhance the resolution of the field emission display.

To achieve the object, the method for manufacturing a cathode panel of a field emission display of the present invention comprises: (a) providing a plate comprising a cathode layer and an emitter layer, wherein the cathode layer and the emitter layer are disposed on the upper surface of the plate; (b) forming a photosensitive insulating layer on the upper surface of the plate; (c) exposing the upper surface of the plate which comprises the photosensitive insulating layer; (d) developing the photosensitive insulating layer on the plate to form a patterned insulating layer; and (e) sintering the patterned insulating layer on the plate. The method for manufacturing a cathode panel of a field emission display of the present invention further comprises a step for forming a patterned gate layer after the step (e). The method for forming the patterned gate layer is not limited. Preferably, the method for forming the patterned gate layer is plating a film by sputtering, coating a photoresist, and then performing exposing, developing, and etching to obtain the patterned gate layer. More preferably, the method for forming the patterned gate layer is coating a photosensitive thick film electrode material, performing exposing and developing to form a patterned gate layer, and then solidifying the patterned gate layer by sintering.

Another method for manufacturing a cathode panel of a field emission display of the present invention comprises: (a) providing a plate comprising a cathode layer and an emitter layer, wherein the cathode layer and the emitter layer are disposed on the upper surface of the plate; (b) forming a photosensitive insulating layer on the upper surface of the plate; (c) forming a photosensitive gate layer on the photosensitive insulating layer; (d) exposing the upper surface of the plate which comprises the photosensitive insulating layer and the photosensitive gate layer; (e) developing the photosensitive insulating layer and the photosensitive gate layer on the plate to form a patterned insulating layer and a patterned gate layer; and (f) sintering the patterned insulating layer and the pattern gate layer on the plate, wherein the photosensitive insulating layer and the photosensitive gate layer perform a cross-linking reaction after exposure.

Preferably, the cathode layer in the step (a) is a patterned cathode layer.

The position relationship between the emitter layer and the cathode layer in the step (a) is not limited. Preferably, the emitter layer overlaps the cathode layer. More preferably, the emitter layer and the cathode layer are formed on the same plane.

The cathode layer in the step (a) comprises a metal material. Preferably, the metal material is silver, copper, chromium, aluminum, molybdenum, gold, rubidium, platinum, or a combination thereof. Preferably, the aforementioned cathode layer is a thin film electrode and the manufacturing method thereof is not limited. Preferably, the method for forming a thin film electrode is plating a film by sputtering, coating a photoresist, and then performing exposing, developing, and etching to obtain the cathode layer. More preferably, the aforementioned cathode layer is a thick film electrode and the manufacturing thereof is not limited. Preferably, the method for manufacturing a thick film electrode is forming a patterned cathode layer by screen printing and then solidifying the patterned cathode layer by sintering. More preferably, the method for manufacturing a thick film electrode is coating a photosensitive thick film electrode, performing exposing and developing to form a patterned cathode layer, and solidifying the patterned cathode layer by sintering.

The emitter layer in the step (a) comprises a carbon-containing compound. Preferably, the carbon-containing compound is graphite, diamond, diamond-like carbon, carbon nanotube, buckminsterfullerene, or a combination thereof.

The method for forming the photosensitive insulating layer of the present invention is not limited. Preferably, the method for forming the photosensitive insulating layer of the present invention is screen printing, die coating, film pasting, scraping, or spin coating. The aforementioned methods can further comprise a step for drying to remove the solvent in the materials.

Preferably, the photosensitive insulating layer of the present invention comprises an insulating material, a photosensitive material, and a polymer. Preferably, the insulating material in the aforementioned method is silica, aluminum oxide, lead oxide, titanium oxide, boron oxide, chromium oxide, magnesium oxide, or a combination thereof.

The method for manufacturing the photosensitive gate layer of the present invention is not limited. Preferably, the method for manufacturing the photosensitive gate layer of the present invention is screen printing, die coating, film pasting, scraping, and spin coating. The aforementioned methods can further comprise a step for drying to remove the solvent in the materials.

Preferably, the photosensitive gate layer of the present invention comprises a metal material, a photosensitive material, and a polymer.

Preferably, the photosensitive gate layer is thinner than the photosensitive insulating layer in the present invention.

The range of sintering temperature for the patterned insulating layer and the patterned gate layer of the present invention is 400° C. to 600° C.

### BRIEF DESCRIPTION OF THE DRAWINGS

FIGS. 1a to 1h are charts of a process for manufacturing a cathode panel of a preferred embodiment of the present invention; and

FIGS. 2a to 2e are charts of a process for manufacturing a cathode panel of another preferred embodiment of the present invention.

### DETAILED DESCRIPTION OF THE PREFERRED EMBODIMENT

### Embodiment 1

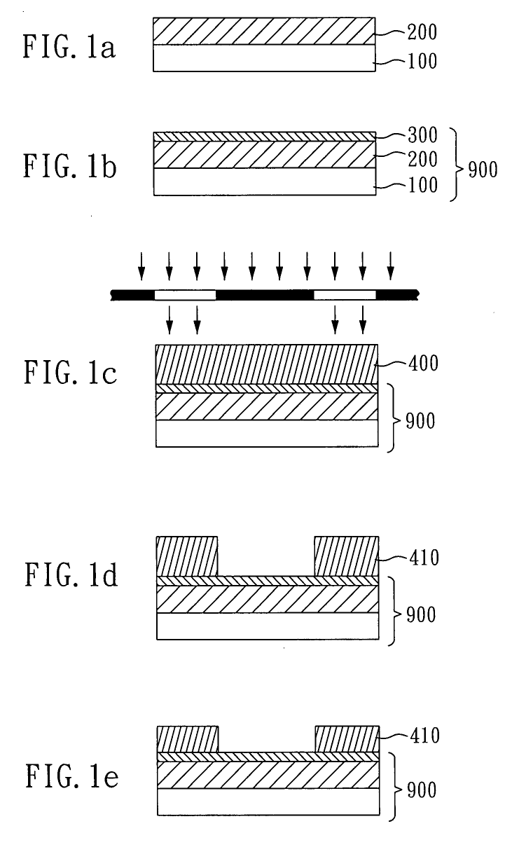

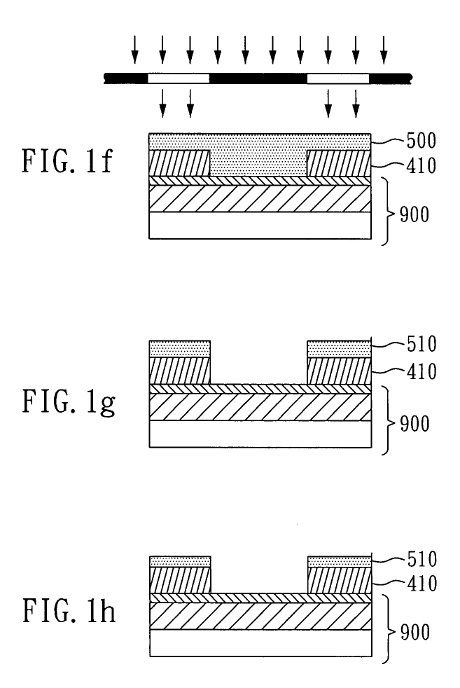

Please refer to FIGS. 1a to 1h which show a method for manufacturing a cathode panel of a field emission display of the present invention. In the present embodiment, a silver electrode paste is printed on a substrate 100 by screen printing first. The photographic layer on the screen has suitable openings to permit the silver electrode paste to filter through. A silver electrode layer with about 50 μm pattern line width is formed on the substrate 100 by printing. Subsequently, the organic solvent in the silver electrode paste is removed by a drying step. Then, the silver electrode layer is solidified by sintering at 500° C. to accomplish a cathode layer 200. The pattern line width of the silver electrode layer contracts to 40 μm after sintering.

Then, an emitter paste is printed on the substrate 100 by the aforementioned screen printing. Subsequently, an emitter layer 300 is accomplished by drying and sintering, and a plate 900 is obtained, as shown in FIG. 1b. The emitter layer 300 comprises graphite and carbon nanotubes. When an electric field is applied, the emitter layer 300 ejects electrons.

A photosensitive insulating layer 400 is printed on the upper surface of the plate 900 by screen printing. The photosensitive insulating layer 400 comprises an organic solvent, a dispersion agent, a photosensitive material, an insulating material, and a colloid material. The dispersion agent comprises mono-alkoxy type agent and sulfonic acid sodium salt. The insulating material comprises silica, aluminum oxide, lead oxide, and boron oxide. The colloid material comprises cellulose, carbitol, and dimethylpyrrolidone. After printing the photosensitive insulating layer 400, the solvent in the photosensitive insulating layer is removed by a drying step and then the photosensitive insulating layer 400 on the plate 900 is exposed, as shown in FIG. 1c.

Subsequently, the photosensitive insulating layer 400 on the plate 900 is developed. In the exposure step, the photosensitive insulating layer 400 performs a cross-linking reaction, and the exposed photosensitive insulating layer is retained on the plate 900 in the developing step. On the contrary, the disposed photosensitive insulating layer is removed in the developing step. Thereby, a patterned insulating layer 410 is formed, as shown in FIG. 1d.

The patterned insulating layer 410 on the plate 900 is sintered at high temperature to completely solidify the insulating material. The sintering temperature in the present embodiment is 550° C. and the sintering time is 30 minutes. After sintering, the patterned insulating layer 410 is accomplished, as shown in FIG. 1e.

Then, a photosensitive gate layer 500 is formed on the plate 900 having the patterned insulating layer 410 thereon by screen printing. In the present embodiment, the photosensitive gate layer 500 is a photosensitive silver electrode layer. The photosensitive silver electrode layer comprises an organic solvent, a dispersion agent, a photosensitive material, silver powder, and a colloid material. The dispersion agent comprises mono-alkoxy agent and sulfonic acid sodium salt. The silver powder comprises silver microparticles and a small amount of platinum microparticles. After printing the photosensitive silver electrode layer, the solvent in the photosensitive silver electrode layer is removed by a drying step and then the photosensitive silver electrode layer on the plate 900 is exposed, as shown in FIG. 1f.

The photosensitive silver electrode layer on the plate 900 is developed. In the exposure step, the photosensitive silver electrode layer performs a cross-linking reaction, and the exposed photosensitive silver electrode layer is retained on the plate 900 in the developing step. On the contrary, the disposed photosensitive silver electrode layer is removed in the developing step. Thereby, a patterned gate layer 510 is formed, as shown in FIG. 1g.

Finally, the patterned gate layer 510 on the plate 900 is sintered at high temperature. The sintering temperature is 560° C. and maintained for 20 minutes to completely sinter the silver microparticles so as to accomplish a cathode panel of a field emission display, as shown in FIG. 1h.

### Embodiment 2

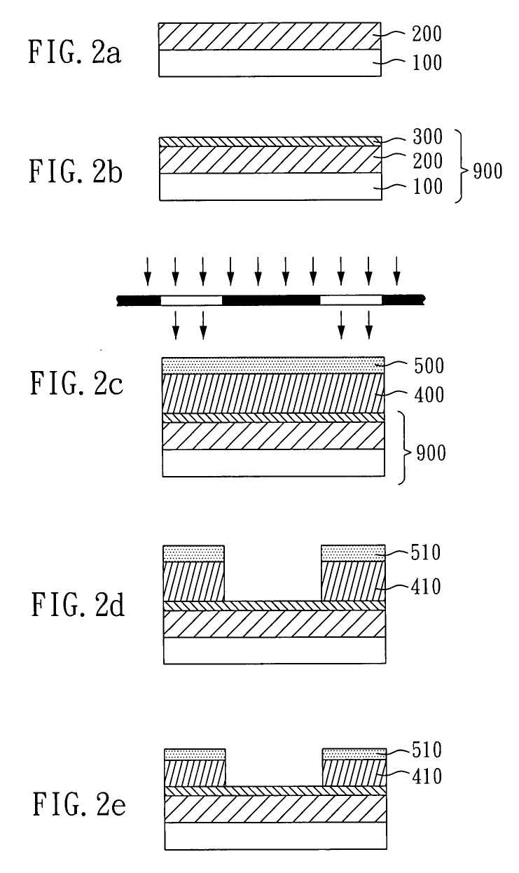

Referring to FIGS. 2a to 2e, a silver electrode paste is printed on a substrate 100 by screen printing first. The photographic layer on the screen has suitable openings to permit the silver electrode paste to filter through. A silver electrode layer with about 50 μm pattern line width is formed on the substrate 100 by printing. Subsequently, the organic solvent in the silver electrode paste is removed by a drying step. Then, the silver electrode layer is solidified by sintering at 500° C. to accomplish a cathode layer 200. The pattern line width of the silver electrode layer contracts to 40 μm after sintering.

Then, an emitter paste is printed on the substrate 100 by the aforementioned screen printing. Subsequently, an emitter layer 300 is accomplished by drying and sintering and a plate 900 is obtained, as shown in FIG. 1b. The emitter layer 300 comprises graphite and carbon nanotubes. When an electric field is applied, the emitter layer 300 ejects electrons.

A photosensitive insulating layer 400 is printed on the upper surface of the plate 900 by screen printing. The photosensitive insulating layer 400 comprises an organic solvent, a dispersion agent, a photosensitive material, an insulating material, and a colloid material. The dispersion agent comprises mono-alkoxy pyrophosphate agent and sulfonic acid sodium salt. The insulating material comprises silica, aluminum oxide, lead oxide, and boron oxide. The colloid material comprises cellulose, carbitol, and dimethylpyrrolidone. After printing the photosensitive insulating layer 400, the solvent in the photosensitive insulating layer is removed by a drying step. The thickness of the dried photosensitive insulating layer 400 is 8 μm.

A photosensitive gate layer 500 is formed on the plate 900 having the photosensitive insulating layer 400 thereon by screen printing. In the present embodiment, the photosensitive gate layer 500 is a photosensitive silver electrode layer. The photosensitive silver electrode layer comprises an organic solvent, a dispersion agent, a photosensitive material, silver powder, and a colloid material. The dispersion agent comprises mono-alkoxy pyrophosphate agent and sulfonic acid sodium salt. The silver powder comprises silver microparticles and a small amount of platinum microparticles. After printing the photosensitive silver electrode layer, the solvent in the photosensitive silver electrode layer is removed by a drying step. The thickness of the dried photosensitive insulating layer 400 is 1.3 μm, as shown in FIG. 2c.

The photosensitive gate layer 500 on the plate 900 and the plate 900 are exposed and developed. In the exposure step, the photosensitive insulating layer 400 and the photosensitive gate layer 500 perform a cross-linking reaction, and the exposed photosensitive insulating layer 400 and the photosensitive gate layer 500 are retained on the plate 900 in the developing step. On the contrary, the disposed photosensitive insulating layer 400 and the photosensitive gate layer 500 are removed in the developing step. Thereby, a patterned gate layer 510 and a patterned insulating layer 400 are formed simultaneously, as shown in FIG. 2d.

Finally, the patterned gate layer 510 and the patterned insulating layer 400 on the plate 900 are sintered at high temperature together. The thicknesses of the patterned gate layer 510 and the patterned insulating layer 410 are 1.0 μm and 5.0 μm, respectively. The sintering temperature is 560° C. and maintained for 30 minutes to completely sinter the patterned gate layer 510 and the patterned insulating layer 410 so as to accomplish a cathode panel of a field emission display, as shown in FIG. 2e.

The present invention utilizes a photosensitive insulating layer and a photosensitive gate layer to form a patterned insulating layer and a patterned gate layer by the same lithographic process so as to simplify the manufacture. On the other hand, precise screen alignment utilizing a photosensitive insulating layer and a photosensitive gate layer can omit the need for precise screen alignment so as to enhance the yield. Of course, in the aforementioned embodiments, the photosensitive gate layer can be also applied in the process for manufacturing the cathode layer to enhance the resolution.

Although the present invention has been explained in relation to its preferred embodiment, it is to be understood that many other possible modifications and variations can be made without departing from the spirit and scope of the invention as hereinafter claimed.

What is claimed is:

1. A method for manufacturing a cathode panel of a field emission display, comprising:
(a) providing a plate comprising a cathode layer and an emitter layer, wherein the cathode layer and the emitter layer are disposed on the upper surface of the plate;
(b) forming a photosensitive insulating layer on the upper surface of the plate;
(c) exposing the upper surface of the plate which comprises the photosensitive insulating layer;
(d) developing the photosensitive insulating layer on the plate to form a patterned insulating layer; and
(e) sintering the patterned insulating layer on the plate,
wherein, the photosensitive insulating layer performs a cross-linking reaction after exposure.

2. The method as claimed in claim 1, further comprising the following steps after the step (e):
(f) forming a photosensitive gate layer on the upper surface of the plate and the patterned insulating layer;
(g) exposing and developing the photosensitive gate layer on the plate to pattern the gate layer; and
(h) sintering the patterned gate layer on the plate.

3. A method for manufacturing a cathode panel of a field emission display, comprising:
(a) providing a plate comprising a cathode layer, an emitter layer, and an insulating layer, wherein the cathode layer, the emitter layer, and the insulating layer are disposed on the upper surface of the plate;
(b) forming a photosensitive a gate layer on the upper surface the plate;
(c) exposing the upper surface of the plate which comprises the photosensitive gate layer;
(d) developing the photosensitive gate layer on the plate to form a patterned gate layer; and
(e) sintering the patterned gate layer on the plate,
wherein, the photosensitive gate layer performs a cross-linking reaction after exposure.

4. The method as claimed in claim 1, wherein the cathode layer in the step (a) comprises a metal material, and the metal material is selected from the group consisting of silver, copper, chromium, aluminum, molybdenum, gold, rubidium, platinum, and a combination thereof.

5. The method as claimed in claim 1, wherein the emitter layer in the step (a) comprises a carbon-containing compound, the carbon-containing compound is selected from the group consisting of graphite, diamond, diamond-like carbon, carbon nanotube, buckminsterfullerene, and a combination thereof.

6. The method as claimed in claim 1, wherein the photosensitive insulating layer in the step (b) comprises an insulating material, a photosensitive material, and a polymer.

7. The method as claimed in claim 5, wherein the insulating material comprises a compound, and the compound is selected from the group consisting of silica, aluminum oxide, lead oxide, titanium oxide, boron oxide, chromium oxide, and magnesium oxide.

8. The method as claimed in claim 1, wherein the range of sintering temperature in the step (e) is 400° C. to 600° C.

9. A method for manufacturing a cathode panel of a field emission display, comprising:
(a) providing a plate comprising a cathode layer and an emitter layer, wherein the cathode layer and the emitter layer are disposed on the upper surface of the plate;
(b) forming a photosensitive insulating layer on the upper surface of the plate;
(c) forming a photosensitive gate layer on the photosensitive insulating layer;
(d) exposing the upper surface of the plate which comprises the photosensitive insulating layer and the photosensitive gate layer;
(e) developing the photosensitive insulating layer and the photosensitive gate layer on the plate to form a patterned insulating layer and a patterned gate layer; and
(f) sintering the patterned insulating layer and the pattern gate layer on the plate,
wherein, the photosensitive insulating layer and the photosensitive gate layer perform a cross-linking reaction after exposure.

10. The method as claimed in claim 9, wherein the cathode layer in the step (a) comprises a metal material, and the metal material is selected from the group consisting of silver, copper, chromium, aluminum, molybdenum, gold, rubidium, platinum, and a combination thereof.

11. The method as claimed in claim 9, wherein the emitter layer in the step (a) comprises a carbon-containing compound, the carbon-containing compound is selected from the group consisting of graphite, diamond, diamond-like carbon, carbon nanotube, buckminsterfullerene, and a combination thereof.

12. The method as claimed in claim 9, wherein the photosensitive insulating layer in the step (b) comprises an insulating material, a photosensitive material, and a polymer.

13. The method as claimed in claim 12, wherein the insulating material comprises a compound, and the compound is selected from the group consisting of silica, aluminum oxide, lead oxide, titanium oxide, boron oxide, chromium oxide, and magnesium oxide.

14. The method as claimed in claim 9, wherein the step (c) further comprises a step for drying the photosensitive gate layer.

15. The method as claimed in claim 9, wherein the photosensitive gate layer in the step (c) comprises a metal material, a photosensitive material, and a polymer.

16. The method as claimed in claim 9, wherein the photosensitive gate layer is thinner than the photosensitive insulating layer in the step (c).

17. The method as claimed in claim 9, wherein the range of sintering temperature in the step (e) is 400 to 600° C.
